(19) United States
(12) Patent Application Publication
(10) Pub. No.: US 2026/0116561 A1
(43) Pub. Date: Apr. 30, 2026

(54) NACELLE FOR AN AIRCRAFT ENGINE

(71) Applicant: Airbus Operations SAS, TOULOUSE (FR)

(72) Inventors: Miloud ALAOUI, TOULOUSE (FR); Quentin GRANGE, TOULOUSE (FR)

(21) Appl. No.: 19/353,684

(22) Filed: Oct. 9, 2025

(30) Foreign Application Priority Data
Oct. 24, 2024 (FR) FR2411650

(51) Int. Cl. B64D 29/00; B64D 27/40

(52) U.S. Cl. CPC B64D 29/00; B64D 27/402

(57) ABSTRACT

A nacelle for a motorization system of an aircraft, wherein the nacelle includes at least one cover mounted in an articulated manner between a closed position and an open position about a hinge axis and, for each cover, at least one motor assembly including an actuating shaft movable in rotation about the hinge axis. The actuating shaft is configured to move the associated cover between the closed position and the open position. With such an arrangement, the motor assembly is integrated into the hinge so as to ensure an optimum footprint and to provide unobstructed access to the core arranged in the nacelle.

### CROSS-REFERENCES TO RELATED APPLICATIONS

This application claims the benefit of the French Patent Application No. FR2411650 filed on Oct. 24, 2024, the entire disclosures of which are incorporated herein by way of reference.

### FIELD OF THE INVENTION

The present invention relates to a nacelle for a motorization system of an aircraft, comprising at least one movable cover and one motor assembly configured to move said at least one movable cover, to a motorization system of an aircraft comprising such a nacelle and to an aircraft comprising at least one such motorization system.

### BACKGROUND OF THE INVENTION

FIG. 1 shows a motorization system 500 of the prior art. This motorization system 500 equips an aircraft and it conventionally comprises a core 502 surrounded by a nacelle 504 which forms, among other things, an aerodynamic surface around the core 502, and the motorization system is generally fixed below a wing of the aircraft by means of an attachment pylon 503.

The nacelle 504 comprises covers 506 which are mounted in an articulated manner on the attachment pylon 503 by means of hinges 508 and which are locked in the closed position by a locking system that locks the covers 506 with respect to one another at a lower longitudinal member 510 integrated into each cover 506.

For maintenance reasons, it is necessary to be able to open the covers 506 by making them pivot about the axes of the hinges 508. To open a cover 506, the technician unlocks the locking system and lifts the cover 506, with the reverse maneuver making it possible to close the cover 506.

An actuator 512a-b is put in place in order to help open a cover 506.

In some arrangements (on the left in FIG. 1), the actuator 512a is mounted between the cover 506 and a structure of the core 502.

In other arrangements (on the right in FIG. 1), the actuator 512b is mounted between the cover 506 and a structure of the attachment pylon 503.

The use of actuators can limit the opening angle of the covers and it is desirable to find an arrangement that allows for greater opening of the covers.

Furthermore, with the arrangements of the prior art, the actuators 512b are potentially subjected to high temperatures and changing of the core may be hindered by the presence of the actuators 512a.

It is therefore desirable to find an arrangement that provides improvements.

### SUMMARY OF THE INVENTION

An object of the present invention is to propose a nacelle for a motorization system of an aircraft, comprising at least one movable cover and one motor assembly configured to move the at least one movable cover.

To that end, a nacelle for a motorization system of an aircraft is proposed, the nacelle extending about a longitudinal axis and comprising:
at least one cover mounted in an articulated manner between a closed position and an open position about a hinge axis which extends parallel to the longitudinal axis X,
for each cover, at least one motor assembly comprising an actuating shaft movable in rotation about the hinge axis and wherein the actuating shaft is configured to move the associated cover between the closed position and the open position.

In this way, the motor assembly is integrated into the hinge so as to ensure an optimum footprint and to provide unobstructed access to the core arranged in the nacelle.

Advantageously, the motor assembly comprises a motor with a motor shaft overall parallel to the hinge axis and a gear system having an input pinion integral with the motor shaft and an output pinion integral with the actuating shaft, where the gear ratio of the gear system is greater than 1.

According to a particular aspect of the invention, the motor is an electric motor.

According to another particular aspect of the invention, the motor is a hydraulic motor.

According to yet another particular aspect of the invention, the motor assembly comprises a locking arrangement configured to lock and unlock the position of the cover.

According to a particular aspect of the invention, the motor is configured to be fixed to an attachment pylon of the aircraft and the actuating shaft is fixed to the cover.

According to a variant, the motor is fixed to the cover and the actuating shaft is configured to be fixed to an attachment pylon of the aircraft.

According to a particular aspect of this variant, the cover comprises an inner wall and an outer wall which together define a housing and the motor is fixed in the housing.

According to a particular aspect of the invention, each cover comprises two motor assemblies spaced apart from one another along the hinge axis.

The invention also relates to a motorization system for an aircraft comprising a core and a nacelle as described above surrounding the core.

The invention also relates to an aircraft comprising at least one such motorization system.

### BRIEF DESCRIPTION OF THE DRAWINGS

The abovementioned features of the invention, along with others, will become more clearly apparent upon reading the following description of one exemplary embodiment, the description being given with reference to the appended drawings, in which:

FIG. 1 is a schematic representation in front view of a nacelle of the prior art,

FIG. 2 is a side view of an aircraft comprising a nacelle according to the invention,

FIG. 3 is a schematic representation in front view of a nacelle according to the invention in the closed position for each cover,

FIG. 4 is a schematic representation in front view of the nacelle of FIG. 3 in the closed position for one of the covers and in the partially open position for the other cover, and

FIG. 5 is a partial schematic representation in plan view of a nacelle of FIG. 3.

### DETAILED DESCRIPTION OF THE PREFERRED EMBODIMENTS

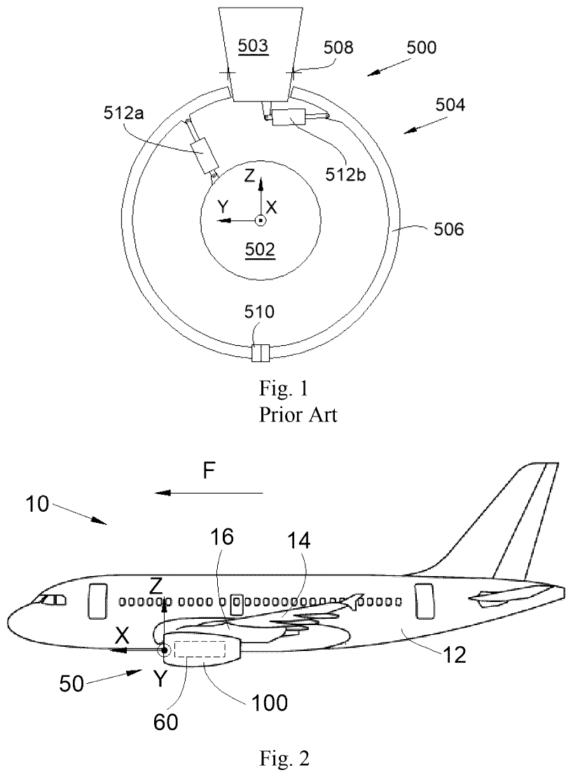

In the following description, terms relating to a position are considered with reference to an aircraft in a position of forward movement as shown in FIG. 2 and in which the arrow F shows the direction of forward movement of the aircraft in flight.

FIG. 2 shows an aircraft 10 comprising a fuselage 12, on either side of which a wing 14 is fixed. Each wing 14 bears at least one motorization system 50 by means of an attachment pylon 16 fixed between a structure of the wing 14 and a structure of the attachment pylon 16.

The motorization system 50 comprises a core 60 (shown in dashed lines in FIG. 2) surrounded by a nacelle 100 according to the invention.

In the following description, and by convention, X denotes the longitudinal axis of the nacelle 100 which is parallel to the longitudinal axis of the aircraft 10 or the roll axis, oriented positively in the direction of forward movement of the aircraft 10, Y denotes the transverse axis, which is parallel to the pitch axis of the aircraft 10, which is horizontal when the aircraft 10 is on the ground, and Z denotes the vertical axis, which is parallel to the yaw axis when the aircraft 10 is on the ground, these three directions X, Y and Z being mutually orthogonal.

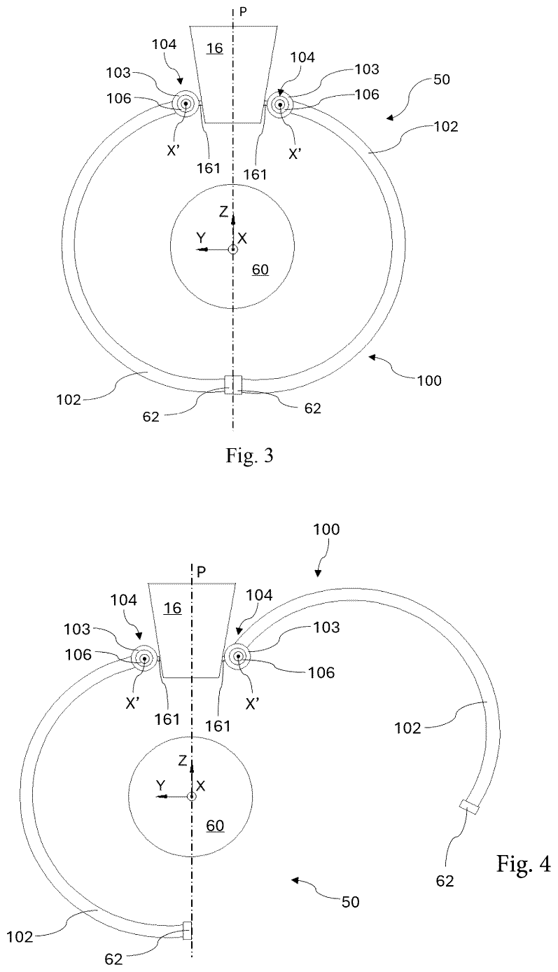

The nacelle 100 has a vertical median plane P of symmetry which coincides with the vertical plane XZ and, in the embodiment of the invention shown in FIG. 3, the nacelle 100 comprises, on either side of the vertical median plane P, a cover 102.

Each cover 102 here takes the form of a half-cylinder so as to form together a cylinder surrounding the core 60.

The core 60 takes the form, for example, of a turbofan with a fan at the front. The cover 102 can then constitute the cover for the fan or the cover for the thrust reverser system.

Each cover 102 is mounted in an articulated manner on a structure which may be a structure of the attachment pylon 16. Each cover 102 is articulated about a hinge axis 103 and each cover 102 is movable between a closed position, in which the cover 102 is closed around the core 60, and an open position in which the cover 102 is moved away from the core 60. In FIG. 4, the port cover 102 is in the open position and the starboard cover 102 is in the closed position.

In the closed position, the two covers 102 come into contact with one another, at a lower longitudinal member 62 of each cover 102. Each cover 102 thus comes into contact with the lower longitudinal member 62 of the other cover 102, at its own lower longitudinal member 62, which is, in the closed position, arranged at the bottom part of the nacelle 100, at 6 o'clock.

The hinge axes 103 are arranged in the top part of each cover 102 and the covers 102 are mounted in an articulated manner on the attachment pylon 16 about the associated hinge axis 103.

In order to lock each cover 102 in the closed position, the nacelle 100 may comprise locking systems (not shown) which are accessible from outside the nacelle 100 by a technician. Each locking system may take any form known to the person skilled in the art and it alternately assumes a locked position, in which it locks the associated cover 102 in the closed position, or an unlocked position, in which it does not lock the associated cover 102, which is then free to move from the closed position to the open position and vice versa. For reasons of redundancy, each cover 102 is equipped with at least two separate locking systems.

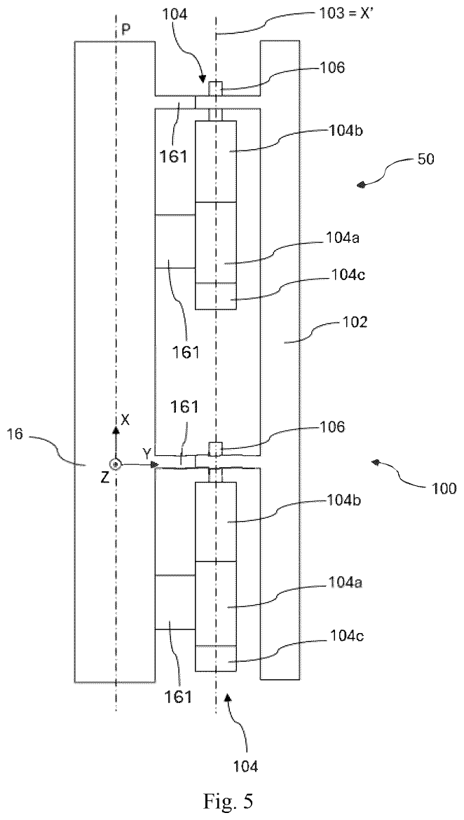

In general, the nacelle 100 comprises at least one cover 102 and at least one motor assembly 104 for each cover 102. In the embodiment of the invention shown in FIGS. 3 and 4, a single motor assembly 104 for each cover 102 can be seen. Although the invention could make it possible to move the cover 102 in rotation by using only one motor assembly 104 per cover 102, provision is made for there to be two motor assemblies 104 (as shown in FIG. 5), or more, per cover 102 in order to distribute the torque necessary to move each cover 2 across the various motor assemblies 104 and to improve the safety of the operators by introducing force paths that are independent of one another.

Each motor assembly 104 has an actuating shaft 106 which is movable in rotation about an axis of rotation X′ which extends overall coaxially with the hinge axis 103 of the cover 102, that is to say, allowing for the design tolerances. In other words, the actuating shaft 106 is movable in rotation about the hinge axis 103.

Each motor assembly 104 is arranged to rotate each actuating shaft 106 alternately in an opening direction so as to move the associated cover 102 from the closed position into the open position and in a closing direction so as to move the associated cover 102 from the open position into the closed position. The opening direction is opposite to the closing direction.

With such an arrangement, the motor assembly 104 is integrated into the hinge between the cover and the attachment pylon 16 so as to ensure an optimum footprint. Moreover, such an arrangement makes it possible to provide unobstructed access to the core arranged in the nacelle. Indeed, it is thus no longer necessary to implement an actuator system between the attachment pylon and the cover, or between the core and the cover. Access to the core is thus enabled and maintenance operations are facilitated since operators have a larger working space, especially when the core needs to be changed and therefore removed from the nacelle.

To actuate each motor assembly 104, a control unit (not shown) is provided to control rotation in one direction or the other and to stop rotation, as required. The control unit takes the form, for example, of a processor which can be supplemented by a random-access memory (RAM), a read-only memory (ROM) or a flash memory, a storage unit or storage media drive (STCK), such as an SD (secure digital) card reader or hard disk drive (HDD), and a communication interface for communicating with the motor assembly 104.

With such an arrangement, it is therefore sufficient to control the motor assembly 104 in order to rotate the actuating shaft(s) 106 to open or close each associated cover 102 with a simple system having a large opening angle.

In addition, the motor assemblies 104 are arranged in the upper part of the nacelle 100, that is to say, overall at 12 o'clock, and in the vicinity of the attachment pylon 16, that is to say, at a distance from any thermal radiation coming from the core 60. As shown in FIG. 5, each motor assembly 104 may be fixed directly to the attachment pylon 16, or to a structure 161 which is itself fixed to the attachment pylon 16. More precisely, the motor 104 as well as the gearbox 104b and the locking arrangement 104c, when they are used (and which are described below in this description), are fixed to the attachment pylon 16. The actuating shaft 106 is in turn fixed to the cover 102. In this case, the motor 104, as well as the gearbox 104b and the locking arrangement 104c (when used), remain fixed with respect to the attachment pylon 16 and the actuating shaft 106 pivots with the cover 102 about the hinge axis 103 (which is overall identical to the axis of rotation X′) when opening/closing the cover 102.

In a variant (not shown), each motor assembly 104 can be integrated into the thickness of a wall of the cover 102, close to the attachment pylon 16. More precisely, the cover 102 comprises an inner wall and an outer wall, which together define a housing in which the motor 104a as well as the gearbox 104b and the locking arrangement 104c (when used) are fixed. The actuating shaft 106 is, in turn, fixed to the attachment pylon 16. In this case, during pivoting of the actuating shaft 106, the cover 102 and the motor 104a, as well as the gearbox 104b and the locking arrangement 104c (when used), pivot about the hinge axis 103 (which is overall identical to the axis of rotation X′) when opening/closing the cover 102. Such an implementation makes it possible to provide protection of the motor assembly 104, in particular against heat. Thus, this particular arrangement advantageously makes it possible to prolong the service life of the motor assembly 104, to reduce the risk of potential failures occurring within the motor assembly and to reduce the manufacturing costs of the motor assembly, as well as the weight of the motor assembly, since it is then possible to use materials requiring a lower temperature resistance than when the motor assembly 104 is exposed to the radiation from the core 60 to a greater extent.

The motor assembly 104 here comprises an electric motor 104a with a motor shaft parallel to the axis of rotation X′ and, preferably, a gearbox 104b which extends overall as a continuation of the electric motor 104a and which extends overall parallel to the axis of rotation X′. Preferably, the gearbox 104b extends coaxially with the axis of rotation X′ (and therefore with the hinge axis 103) in order to limit the footprint of the motor assembly 104. The gearbox 104b is preferably of the compact type with a high level of meshing and comprises, for example, a gear system comprising planetary gear sets arranged in series.

To facilitate the movement of the cover 102, the gear ratio of the gear system of the gearbox 104b is greater than 1. The installation of a gear system where the gear ratio is greater reduces the torque required to open and close the cover 102.

In this example, the gearbox 104b comprises a gear system having an input pinion integral with the motor shaft and an output pinion integral with the actuating shaft 106.

The electric motor 104a of the assembly 104 is electrically powered by an electrical source and is controlled in rotation by the control unit.

The electric motor 104a is thus arranged overall coaxially with the axis of the hinge 103 so as to provide a significant saving of space and better protection, in particular against heat.

The motor assembly 104 may also comprise a locking arrangement 104c making it possible to hold the cover 102 in an open position, or to prevent the cover 102 from closing, in particular in the event of loss of the electrical source of the electric motor. This locking arrangement 104c can thus have a function of holding the covers 102 in their open position, and/or of securing the covers in the event of a system failure/breakdown. The locking arrangement 104c can, for example, take the form of a mechanical brake system that can be actuated at any time during the travel or of a mechanical lock system that can be actuated, preferably, only in the fully deployed position. It is conceivable that the lock is actuated automatically in the fully deployed position and that it is deactivated by the action of a solenoid supplied with current, or else that it is actuated and deactivated by the action of the solenoid. It should be noted that in the event of loss of the electrical source, the implementation of a rheostatic braking system (i.e., discharge resistors) could be considered, which would control the lowering of the cover 102 at a speed that is slow enough not to be dangerous for the operators, in order to prevent the cover 102 from remaining locked in the fully open position.

Thus, the implementation of a system for holding the covers 102 in the open position is no longer necessary. However, for reasons of redundancy and safety, the nacelle 100 could be equipped, in addition to the motor assembly 104, for each cover 102, with a holding system (not shown) used only during maintenance operations. Such a holding system is, for example, fixed between the core 60 and the cover 102. Such a holding system may, for example, take the form of a holding rod, also called a retaining rod or support arm.

In order to know the position of each cover 102, and thus to be able to stop the motor assembly 104 when necessary, the motor assembly 104 can be equipped with a position sensor which is configured to detect the angular position of the actuating shaft 106 and therefore of the associated cover 102.

For safety reasons, and to prevent the cover 102 from going below the closed position or beyond the open position, the motor assembly 104 may comprise stops limiting the rotational movement of the actuating shaft 106. It is therefore possible to implement a stop which stops the rotation of the actuating shaft when it has reached the position corresponding to the closed position of the cover 102, and a stop which stops the rotation of the actuating shaft when it has reached the position corresponding to the open position of the cover 102. For example, the stops may be digital stops which are programmed for each electric motor 104a. In a variant, the stops may be mechanical stops arranged in the hinge axes or stops fixed to the pylon which exert an action on the cover 102 when the open or closed position of the cover 102 has been reached.

According to one configuration, the electric motor of the assembly 104a is powered by electrical energy coming from the electrical network of the aircraft (itself connected to a local electrical network on the ground), or by a battery, for example, which can be remote from the attachment pylon 16; the battery may be either in the aircraft or on the ground.

As an alternative to the electric motor as described above, the engine assembly 104 may comprise a hydraulic motor supplied with hydraulic energy coming from an aircraft cooling system, such as an air conditioning system, or by an external hydraulic energy source, which can be remote from the attachment pylon 16.

In addition, the motor assembly 104 comprising a hydraulic motor may also be powered by an electric motor, hydraulic pump and reservoir assembly powered by electrical energy from the aircraft electrical network (itself connected to a local electrical network on the ground), or by a battery for example, which can be remote from the attachment pylon 16, the battery being able to be either in the aircraft or on the ground.

The invention has been described above for covers 102 surrounding the core 60 of the motorization system 50. The invention can also be applied to other types of covers, and, in particular, to maintenance covers.

While at least one exemplary embodiment of the present invention(s) is disclosed herein, it should be understood that modifications, substitutions and alternatives may be apparent to one of ordinary skill in the art and can be made without departing from the scope of this disclosure. This disclosure is intended to cover any adaptations or variations of the exemplary embodiment(s). In addition, in this disclosure, the terms “comprise” or “comprising” do not exclude other elements or steps, the terms “a” or “one” do not exclude a plural number, and the term “or” means either or both. Furthermore, characteristics or steps which have been described may also be used in combination with other characteristics or steps and in any order unless the disclosure or context suggests otherwise. This disclosure hereby incorporates by reference the complete disclosure of any patent or application from which it claims benefit or priority.

1. A nacelle for a motorization system of an aircraft, said nacelle extending about a longitudinal axis and comprising:
at least one cover mounted in an articulated manner between a closed position and an open position about a hinge axis which extends parallel to the longitudinal axis,
for each cover, at least one motor assembly comprising an actuating shaft movable in rotation about said hinge axis and wherein said actuating shaft is configured to move said cover between said closed position and said open position.

2. The nacelle according to claim 1, wherein said at least one motor assembly comprises a motor with a motor shaft overall parallel to said hinge axis and a gear system having an input pinion integral with the motor shaft and an output pinion integral with the actuating shaft, where a gear ratio of the gear system is greater than 1.

3. The nacelle according to claim 2, wherein said motor is an electric motor.

4. The nacelle according to claim 2, wherein said motor is a hydraulic motor.

5. The nacelle according to claim 1, wherein said at least one motor assembly comprises a locking arrangement configured to lock and unlock a position of said cover.

6. The nacelle according to claim 2, wherein said motor is configured to be fixed to an attachment pylon of said aircraft and wherein said actuating shaft is fixed to the cover.

7. The nacelle according to claim 2, wherein said motor is fixed to the cover and wherein said actuating shaft is configured to be fixed to an attachment pylon of said aircraft.

8. The nacelle according to claim 7, wherein said cover comprises an inner wall and an outer wall which together define a housing and wherein said motor is fixed in said housing.

9. The nacelle according to claim 1, wherein each at least one cover comprises two motor assemblies spaced apart from one another along said hinge axis.

10. A motorization system for an aircraft comprising a core and a nacelle according to claim 1 surrounding the core.

11. An aircraft comprising at least one motorization system according to claim 10.
